(19) United States
(12) Patent Application Publication
(10) Pub. No.: US 2024/0030623 A1
(43) Pub. Date: Jan. 25, 2024

(54) ANTENNA

(71) Applicant: Telefonaktiebolaget LM Ericsson (publ), Stockholm (SE)

(72) Inventors: Christoph Staita, Oberaudorf (DE); Philipp Karl Gentner, Wien (AT); Magnus Hubner, Hohenlinden (DE)

(21) Appl. No.: 18/027,805

(22) PCT Filed: Sep. 25, 2020
(86) PCT No.: PCT/EP2020/076855

§ 371 Date: Mar. 22, 2023

(51) Int. Cl. H01Q 21/28; H01Q 21/00; H01Q 3/32; H01Q 1/00

(52) U.S. Cl. CPC H01Q 21/28; H01Q 21/0006; H01Q 3/32; H01Q 1/002; H01Q 1/246

(57) ABSTRACT

We generally describe an antenna comprising: a signal distribution network configured to distribute, through the antenna, an electrical signal having an antenna operating frequency, f, and a plurality of radiating elements, wherein each one of the radiating elements is electrically coupled to the signal distribution network via a corresponding, respective electrical coupling, wherein each one of the electrical couplings comprises a corresponding, respective interface. A signal path length, between a first one of said interfaces and a corresponding, respective first one of said radiating elements, of a first one of said electrical couplings differs from a signal path length, between a second one of said interfaces and a corresponding, respective second one of said radiating elements, of a second one of said electrical couplings by at least 0.05 times a wavelength, λ, corresponding to the antenna operating frequency, f.

### TECHNICAL FIELD

This invention generally relates to an antenna, in which passive intermodulation (PIM) is mitigated or avoided in particular through interface location management.

### BACKGROUND

PIM may be defined as the distortion generated by nonlinear characteristics of passive radio frequency (RF) components. PIM may be most problematic in frequency-division duplexing (FDD) systems, in which (close-by) transmit and receive bands are simultaneously used.

PIM due to non-linearity can be caused by many factors, such as improper material selection (e.g. ferromagnetic materials), thermal effects, mechanical stress, loose mechanical junctions, contaminated surfaces, metal flakes or shavings and faulty craftsmanship during manufacturing.

In a macro cell base station antenna, there are several possibilities for PIM sources. As shown in the example antenna 100 of FIG. 1, such PIM sources can occur in feeding cables 102, connectors 104, power splitters 106, phase shifters 108 and radio frequency distribution networks 110 like cable harness or a full printed circuit board (PCB). The antenna includes, in this example, a radiator 112.

Models for simulations and calculations in the prior art are based on point-source models which are proposed to evaluate the superposition effect of the passive intermodulation products of the forward and reflected PIM in case of a series connection, as shown in the antenna 200 of FIG. 2.

Base station antenna radiators, e.g. dipoles, may be connected to a distribution network via an interface. Typically, these necessary interfaces occur multiple times and have a high risk to be a harmful PIM source. The risk of a PIM failure antenna increases through these interfaces, but it may not be avoidable.

If an antenna is used with zero degree downtilt or very low downtilts, the reverse travelling PIM products (created by the PIM sources) add up constructively at the power splitter since they are all even spaced related to wavelength, as shown for the antenna 300 in FIG. 3. In this example, an electrical signal 302 is fed into the signal distribution network 304. The electrical signal then travels via the interface 306 to the radiator 308 via signal paths 310 and 312. The interfaces 306 are all arranged at a location along the signal path from the signal distribution network 304 to the corresponding, respective radiator 308 so that the signal path length between the interface 306 and the corresponding, respective radiator 308 is the same for all paths.

There are active solutions for PIM cancelation and PIM avoidance, but they have the drawback of increased computation in the signal processing of the baseband data, and may hence increase the power consumption of a site.

### SUMMARY

In order to expand the cell coverage of wireless cellular systems, the number of dipoles (or generally radiating elements) have increased. Especially in massive multiple in multiple out (MIMO) applications, the number of arrays and radiation elements increases significantly. There is, due to the increase in the number of dipoles, also an increase of connection points. At that connection points, radiation elements/radiators (e.g. dipoles) are connected to the signal distribution network (e.g. cables or a printed circuit board). All of these components relate to possible PIM point sources. Since PIM reduces in particular uplink coverage and consequently a drop in uplink sensitivity, and since interference due to PIM has become an escalating industry issue, it is an object according to the present disclosure to provide for an antenna with which PIM is reduced or avoided.

Therefore, according to an aspect of the present disclosure, there is provided an antenna comprising: a signal distribution network configured to distribute, through the antenna, an electrical signal having an antenna operating frequency, f, a plurality of radiating elements, wherein each one of the radiating elements is electrically coupled to the signal distribution network via a corresponding, respective electrical coupling, wherein each one of the electrical couplings comprises a corresponding, respective interface, wherein a signal path length, between a first one of said interfaces and a corresponding, respective first one of said radiating elements, of a first one of said electrical couplings differs from a signal path length, between a second one of said interfaces and a corresponding, respective second one of said radiating elements, of a second one of said electrical couplings by at least 0.05 times a wavelength, A, corresponding to the antenna operating frequency, f By providing this difference in signal path length of the first electrical coupling compared to the second electrical coupling, any PIM signals which may be generated in the antenna, and in particular at the first and second interfaces, may destructively interfere with each other. As a result, PIM may advantageously be reduced or avoided. In particular, destructive summation of the reverse (and/or forward) PIM products through the signal distribution network may be achieved.

In some variants, the signal path length of the first electrical coupling between the signal distribution network and the first radiating element is identical or substantially identical to the signal path length of the second electrical coupling between the signal distribution network and the second radiating element. This may entail that the signal path length, between the first interface and the first radiating element, of the first electrical coupling differs from the signal path length, between the second interface and the second radiating element, of the second electrical coupling by the same amount as the difference between the signal path length, between the signal distribution network (or a predefined location preceding the signal distribution network and arranged between the signal distribution network and the interfaces) and the first interface, of the first electrical coupling and the signal path length, between the signal distribution network (or the aforementioned predefined location preceding the signal distribution network and arranged between the signal distribution network and the interfaces) and the second interface, of the second electrical coupling. There may therefore be a difference in signal path length, between the signal distribution network (or the predefined location preceding the signal distribution network and arranged between the signal distribution network and the interfaces) and the interfaces, respectively, of different couplings even for an antenna with zero tilt. In some examples, a said signal path length between a said interface and the signal distribution network may be based on the predefined location (i.e. predefined reference location) preceding the signal distribution network (and arranged between the signal distribution network and the interfaces) from which the signal path length to the interface is being measured or determined. This predefined location preceding the signal distribution network may then be used as a reference point from which the signal path length to one or more other (or all) interfaces may be measured or determined.

The predefined (reference) location may, for example, be a connector (for example a connector at the antenna housing). In some examples, if there is a cable, for example a coaxial cable, leading from this connector to the signal distribution network (for example to a PCT containing the signal distribution network), then the connection at the signal distribution network (e.g. the connection at the PCB) may be used as a reference location.

In some examples, with such a location as the reference and a signal distribution network designed for equal phases at radiating elements, the sum of the electrical signal path lengths from the reference location to the interfaces plus the electrical signal path lengths from the interfaces to the radiating elements are the same.

In some examples, the phases at the radiating elements may differ from each other to produce beam shaping and/or beam steering, e.g. downtilt. The relative phase of each radiating element may, in some examples, be defined as the phase with reference to a specific radiating element (e.g. radiating element 1 as described below in relation to FIG. 4a) (including values greater than 360°). This can be converted to a relative signal path length, e.g. a relative phase of 360° corresponds to a relative path length of one wavelength. The general equation may then be: “The electrical path length from a reference location preceding the signal distribution network to the interfaces” plus “the electrical signal path length from the interfaces to the radiating elements” equals “the electrical signal path length from the reference location to the specific radiating element (e.g. radiating element 1)” plus “the relative signal path length of the specific radiating element”.

The relative signal path lengths of the radiating elements are, in some examples, predefined values to achieve the wanted radiation characteristics. The overall length between the signal distribution network (i.e. the reference location preceding the signal distribution network) and the respective radiating elements may be defined independent from a downtilt or beam shaping.

In some examples, the signal distribution network is included in the electrical path, and thus in the overall length. The reference location/position may thus be in front of the signal distribution network. In some examples, the signal distribution network comprises one or more splitters, and the reference location/position may be in front of the first splitter.

In some examples, the first and second couplings are neighboring couplings.

The interfaces may correspond to respective feed points of the radiating elements.

The couplings may each be in the form of a continuous cable or may each comprises multiple cables connected to or coupled to each other.

In some examples of the antenna, the antenna operating frequency, f, is between 698 MHz and 80 GHz, in particular between 698 MHz and 960 MHz, and/or between 1695 MHz and 2690 MHz, and/or between 617 MHz and 746 MHz, and/or between 1695 MHz and 2200 MHz, and/or between 3300 MHz and 3800 MHz, and/or between 5150 MHz and 5925 MHz, and/or between 600 MHz and 6000 MHz, and/or between 24 GHz and 80 GHz. The antenna may in particular be operated at an antenna operating frequency, f, of one or more of 600 MHz, 617 MHz, 698 MHz, 746 MHz, 829 MHz, 681.5 MHz, 960 MHz, 1695 MHz, 1947.5 MHz, 2192.5 MHz, 2200 MHz, 2690 MHz, 3300 MHz, 3550 MHz, 3800 MHz, 5150 MHz, 5537.5 MHz, 5925 MHz, 6000 MHz, 24 GHz, 52 GHz and 80 GHz. In particular, the antenna operating frequency, f, may be “698 MHz+n·1 MHz”, with n∈{0, 1, 2, . . . , 79302}.

In some examples of the antenna, the signal path length, between the first interface and the first radiating element, of the first electrical coupling differs from the signal path length, between the second interface and the second radiating element, of the second electrical coupling by less than 1.25λ. The inventors have realized that this is an upper limit of the difference in signal path length up to which PIM may, in some examples, be effectively reduced.

In some examples of the antenna, the signal path length, between the first interface and the first radiating element, of the first electrical coupling differs from the signal path length, between the second interface and the second radiating element, of the second electrical coupling by 0.25λ. This difference in signal path length provides for a particularly high reduction of PIM in some examples, as will be described below.

In some examples, the antenna comprises at least three radiating elements, and wherein the signal path length, between a said interface and a said corresponding, respective radiating element, of a said electrical coupling increases from any one of said electrical couplings to a corresponding, respective consecutive neighboring coupling by an amount which is between 0.05λ and 1.25λ. The signal path length may therefore increase for consecutive neighboring couplings, which may allow for effective PIM reduction while, in some variants, providing for simplification of manufacturing the antenna. In some examples, the amount is a fixed amount between 0.05λ and 1.25λ, and is preferably 0.1λ or 0.2λ or 0.3λ or 0.4λ, more preferably 0.25λ. The signal path length therefore increases incrementally by the same amount between consecutive neighboring couplings, resulting in effective PIM reduction and ease of manufacturing.

In some examples of the antenna, the signal path length, between the first interface and the first radiating element, of the first electrical coupling being different from the signal path length, between the second interface and the second radiating element, of the second electrical coupling is based on one or more of: an electrical length and/or physical length of the first radiating element, in particular of an inner conductor of the first radiating element, being different from an electrical length and/or physical length of the second radiating element, in particular of an inner conductor of the second radiating element; a physical length, between the first interface and the first radiating element, of a first electrical cable for the first electrical coupling being different from a physical length, between the second interface and the second radiating element, of a second electrical cable for the second electrical coupling; a velocity factor of at least a part of the first electrical cable being different from a velocity factor of at least a part of the second electrical cable; a said first electrical cable being coupled or connected to a first dielectric, and in particular a said second electrical cable being coupled or connected to a second dielectric which is different from the first dielectric; the first electrical coupling comprising a first reactance and/or a first inductance and/or a first capacitance, and in particular the second electrical coupling comprising a second reactance different from the first reactance and/or a second inductance different from the first inductance and/or a second capacitance different from the first capacitance; the first radiating element being of a first type and the second radiating element being of a second type, wherein the first type causes a phase delay of a said electrical signal different from a said phase delay caused by the second type; a third dielectric coupled or connected to the first radiating element and/or a fourth dielectric, different from the third dielectric, coupled or connected to the second radiating element; and the first radiating element being rotated with respect to an orientation of the second radiating element.

As will be understood, one or more (or all) of the above options may be used for a single coupling. Furthermore, different one or more options outlined above in order to provide for the difference in signal path length may be used for one or more of the couplings, while other one or more options may be used for one or more other couplings. Therefore, any combination of options may be provided for one or more of the couplings in order to provide for the difference in signal path length.

Providing different electrical and/or physical lengths of the radiating elements may be particularly advantageous as the means to reduce PIM may be established via different radiating elements, without, in some examples, changing other parts of the antenna. This may additionally or alternatively be achieved by providing radiating elements of different types and/or rotating one of the radiating elements with respect to an orientation of one or more other radiating elements.

Changing the physical length of cables may relate to a simple implementation in order to reduce PIM according to the examples as described herein.

Providing a dielectric and/or reactance and/or inductance and/or capacitance as outlined above may allow a simple way to change the effective length of the coupling/cable.

The first and/or second electrical cable may, in some examples, have shielding characteristics allowing for the corresponding, respective dielectric being able to influence the signal path length of the cable. Cables, such as coaxial cables, may, in some examples, not be suitable when aiming to influence the signal path length with a dielectric coupled or connected to the cable, since a coupling between the (e.g. coaxial) cable and the dielectric may not be possible or not be possible to a certain degree.

Throughout the present disclosure, any references to a cable may, in some examples, relate to a transmission line (for example a (micro) strip line). The signal path length of such a transmission line may, in some examples, be influenced by a dielectric connected to or coupled to the transmission line.

In some examples of the antenna, the signal path length, between the first interface and the first radiating element, of the first electrical coupling being different from the signal path length, between the second interface and the second radiating element, of the second electrical coupling is based on a phase-shifting element or unit (comprising for example one or more inductors and/or one or more capacitances), in particular a 90 degree hybrid coupler, being provided in or coupled to one or both of: the first electrical coupling at a first location between the first interface and the first radiating element, and the second electrical coupling at a second location between the second interface and the second radiating element. Such a phase-shifting element or unit may allow for particularly precise control of the phase of the electrical signal in order to optimize reducing PIM.

It has been realized by the inventors that PIM reduction may be improved, the more radiating elements are exploited. Therefore, in some examples, the antenna comprises at least four radiating elements, preferably at least eight radiating elements. In some examples, the antenna is a multiple-input multiple-output, MIMO, antenna.

In some examples of the antenna, the interface comprises one or more of: a soldering joint, an electrical connector, and an interface of an electrical component, in particular of a power splitter and/or a filter and/or a phase delay element. It may hereby be particularly advantageous to arrange the soldering joints at corresponding, respective locations within the antenna along the respective couplings, as the arrangement of soldering joints according to the present disclosure to reduce PIM may be achieved in a particular easy manner.

In some examples, the antenna further comprises a variable phase shifter, coupled or connected (i) between the first interface and the first radiating element to the first electrical coupling and/or (ii) between the second interface and the second radiating element to the second electrical coupling, for shifting a said electrical signal transmitted on (i) the first electrical coupling between the first interface and the first radiating element and/or (ii) the second electrical coupling between the second interface and the second radiating element. Such variable phase shifter may allow for further control of the phase of the electrical signal distributed through the antenna so as to further improve reducing PIM. The variable phase shifter may, in some examples, be an analog phase shifter, which may in particular be remote controlled (e.g. using a digital controlling means).

In some examples, the antenna further comprises a first variable phase shifter and/or a first electrically controllable reactance and/or a fifth dielectric coupled to or comprised in the first electrical coupling, for shifting a said electrical signal transmitted on the first electrical coupling between the first interface and the first radiating element. In some examples, the antenna further comprises a second variable phase shifter and/or a second electrically controllable reactance and/or a sixth dielectric, different from the fifth dielectric, coupled to or comprised in the second electrical coupling, for shifting a said electrical signal transmitted on the second electrical coupling between the second interface and the second radiating element. This equally allows for improved control of the phase of the electrical signal to reduce PIM. In some examples, two movable conducting plates may be used, which form a variable capacitance.

In some examples, a said variable phase shifter is configured to vary a mechanical length of a said electrical coupling for shifting a said electrical signal.

A said variable phase shifter may comprise a 2-port phase shifter (with input and output). Additionally or alternatively, a said variable phase shifter may comprise a 3-port phase shifter, which may further include an integral power distribution to increase a first signal path length and decrease a second signal path length of first and second signal paths, respectively.

In some examples, a said variable phase shifter comprises a movable dielectric configured to shift an electrical signal. A movable dielectric may be a particular simple means to be provided in the antenna to shift the electrical signal.

In some examples of the antenna, one or more of said radiating elements each comprises a group of radiators, and wherein the signal path length between a said interface and a said corresponding, respective radiating element comprises a signal path length between said interface and a feed point of each of the radiators of the corresponding, respective group of radiators. This may allow for reducing the number of phase shifters in the signal distribution network. In order to provide for a group of radiators, a device with a power dividing function may be provided so as to feed the electrical signal to the different radiators of the group of radiators. This device may comprise a power splitter, a phase shifter, a combiner with filters (for example a duplexer and/or diplexer) or any combination thereof.

In some examples of the antenna, when the signal path lengths between (i) a said interface and (ii) at least two radiators, respectively, of the corresponding group of radiators differ from each other, the signal path length between the interface and the group of radiators is based on a mean value of said signal path lengths between said interface and the radiators of the corresponding, respective group of radiators. The different signal path lengths may therefore be provided based on such mean values to ensure PIM reduction in the antenna.

### BRIEF DESCRIPTION OF THE DRAWINGS

These and other aspects of the invention will now be further described, by way of example only, with reference to the accompanying figures, wherein like reference numerals refer to like parts, and in which:

FIG. 1 shows a schematic block diagram of an antenna according to the prior art;

FIG. 2 shows a schematic diagram of an antenna according to the prior art;

FIG. 3 shows a schematic diagram of an antenna according to the prior art;

FIGS. 4a and b show schematic diagrams of antennae according to some example implementations as described herein;

FIG. 5 shows a schematic diagram of an antenna according to some example implementations as described herein;

FIG. 6 shows a schematic diagram of an antenna according to some example implementations as described herein;

FIG. 7 shows PIM reduction versus difference in signal path length according to some example implementations as described herein; and

FIG. 8 shows a perspective view of a schematic illustration of a radiating element according to some example implementations as described herein.

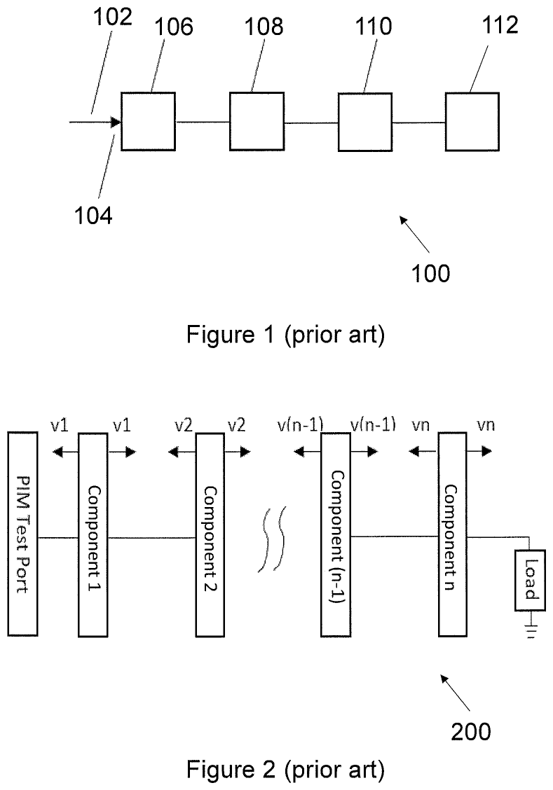

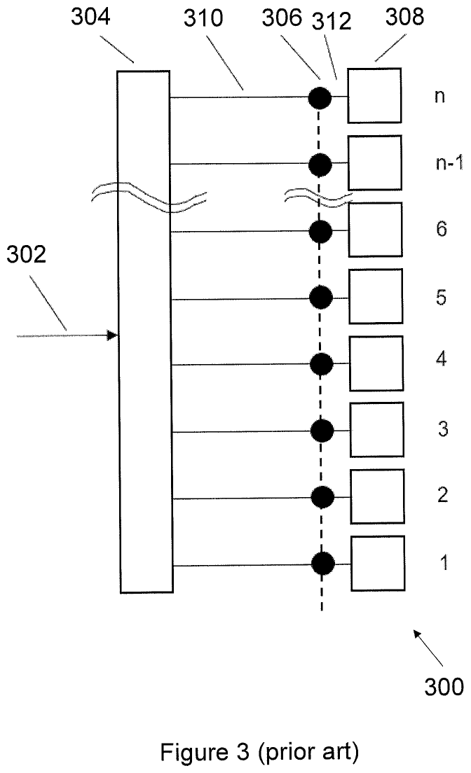

### DETAILED DESCRIPTION

The present disclosure generally relates to PIM cancellation or mitigation/reduction/improvement within an antenna in particular through interface location management. PIM may be avoided by placing the interfaces at specific locations between the signal distribution network and the radiating elements. The interface location management according to the present disclosure further allows for reducing the inter/intra VSWR (Voltage Standing Wave Ratio) peak to avoid multipart PIM. The interfaces may, in some examples, be shifted accordingly in order to reduce PIM as much as possible. This may, in some examples, be achieved by selecting the cable length of different couplings between the signal distribution network and the corresponding, respective radiating elements accordingly. Other options are additionally or alternatively possible in order to provide for a difference in signal path length for the different couplings.

The present disclosure relates in particular, according to some examples, to parallel PIM at point sources. In some variants, areas with possible PIM point sources are managed in a particular way (in some examples based on a predefined increment of a difference in signal path length for a given wavelength) to decrease or avoid PIM. If the increment is large enough (in some examples above 0.05λ, where λ=c/f, with c being the speed of light, 299792458 m/s, and f being the antenna operating frequency), all parallel PIM point sources may add up destructively. The signal path length may vary based on a difference in length of the coupling, in particular a cable between the interface and the radiating element (which may be a dipole).

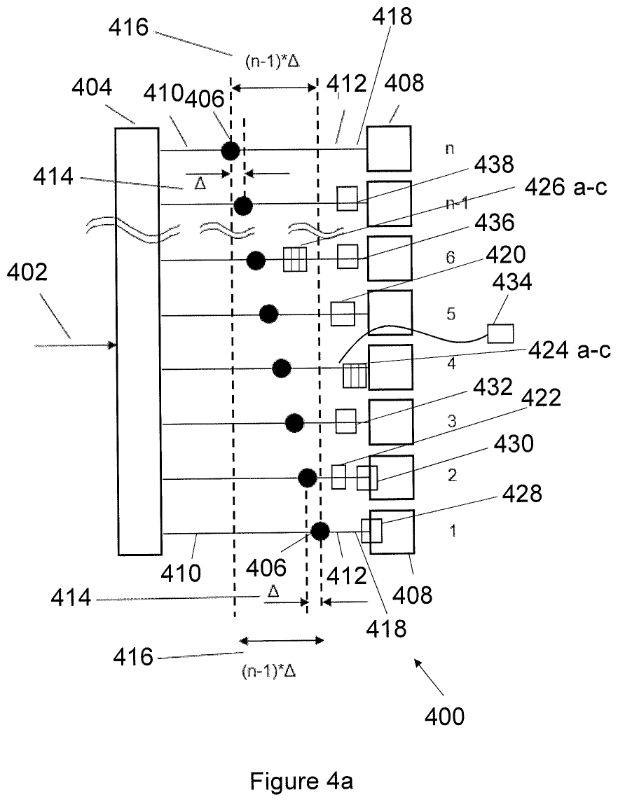

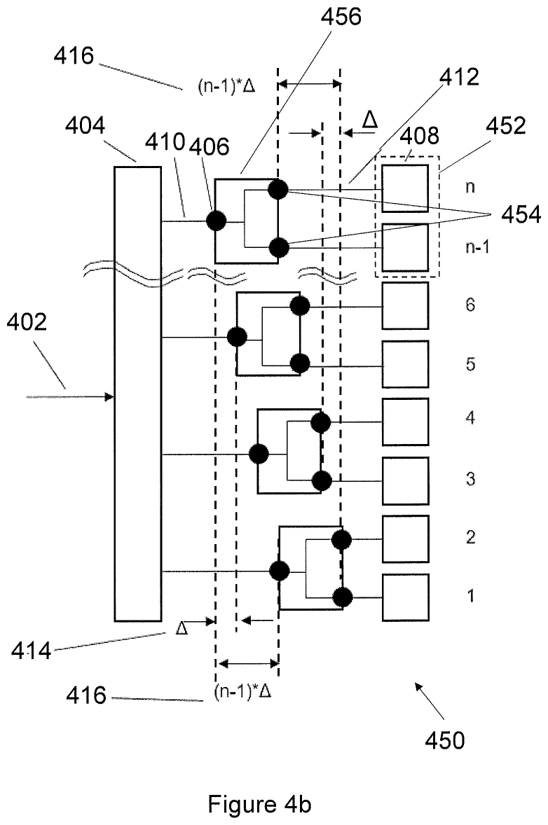

FIG. 4a shows a schematic diagram of an antenna 400 according to some example implementations as described herein.

In this example, an electrical signal 402 is distributed through the antenna 400 via the signal distribution network 404. The electrical signal 402 is provided, in this example, via interfaces 406 to the corresponding, respective radiating elements 408 via electrical couplings 410, 412. One or both of the electrical couplings 410 and 412 may each be in the form of a continuous cable or may each comprise multiple cables connected to or coupled to each other.

In this example, the difference 414 in signal path length between the first radiating element 408 and the corresponding, respective interface 406 compared to the signal path length between the second radiating element 408 and the corresponding, respective interface 406 is Δ (which may be between 0.05λ and 1.25λ). Furthermore, in this example, the difference 416 in signal path length between the n-th radiating element 408 and the corresponding, respective interface 406 compared to the signal path length between the first radiating element 408 and the corresponding, respective interface 406 is (n−1)·Δ (which may be between (n−1)·0.05λ and (n−1)·1.25λ).

The difference in signal path length of the couplings 412 for all consecutive, neighboring couplings increases in this variant by Δ, i.e. by the same increment. It will, however, be appreciated that other possibilities are feasible, for example where the difference in signal path length between the couplings 412 varies randomly between couplings. For example, the difference in signal path length (from the radiating element to the corresponding interface) between the first coupling and the second coupling may be 2Δ, the difference in signal path length between the first coupling in the third coupling may be 5Δ, the difference in signal path length between the first coupling and the fourth coupling may be Δ, the difference in signal path length between the first coupling in the fifth coupling may be 4Δ, etc., or the like (with Δ between 0.05λ and 1.25λ).

In this example, the difference in signal path length between one of the interfaces 406 and the corresponding, respective radiating element 408 is provided based on a different length of the electrical cable 418.

Additionally, in this example, a first dielectric 420 is provided between the fifth radiating element 408 and the corresponding, respective interface 406. This first dielectric 420 influences the signal path length between the fifth radiating element 408 and the corresponding, respective interface 406. As will be appreciated, such a dielectric may be provided for one or more of the other couplings 412. In this example, a second dielectric 422, which is different from the first dielectric 420, is provided between the second radiating element 408 and the corresponding, respective interface 406.

Furthermore, in this example, a first reactance 424a, a first inductance 424b and a first capacitance 424c are provided between the fourth radiating element 408 and the corresponding, respective interface 406, although only one or two of the first reactance 424a, the first inductance 424b and the first capacitance 424c may be provided in some variants. As will be appreciated, such reactance and/or inductance and/or capacitance may be provided for one or more of the other couplings 412. In this example, a second reactance 426a different from the first reactance 424a, a second inductance 426b different from the first inductance 424b, and a second capacitance 426c different from the first capacitance 424c are provided between the sixth radiating element 408 and the corresponding, respective interface 406.

Further still, in this example, a third dielectric 428 is coupled or connected to the first radiating element 408. As will be appreciated, one or more further dielectrics may be coupled or connected to one or more of the other radiating elements (with or without the third dielectric 428 being coupled or connected to the first radiating element 408). In this example, a fourth dielectric 430 is coupled or connected to the second radiating element 408.

In this example, a phase-shifting element or unit 432 is arranged at the coupling between the third radiating element 408 and the corresponding, respective interface 406. The phase-shifting element or unit 432 may in particular be a 90 degree hybrid coupler. As will be appreciated, such a phase-shifting element or unit may be arranged at one or more other couplings (with or without such a phase-shifting element or unit being arranged at the coupling between the third radiating element and the corresponding, respective interface).

Furthermore, in this example, a variable phase shifter 434 is coupled to the coupling between the fourth radiating element 408 and the corresponding, respective interface 406. As will be appreciated, such a variable phase shifter may be arranged at one or more other couplings (with or without such a variable phase shifter being arranged at the coupling between the fourth radiating element and the corresponding, respective interface).

In this example, a first variable phase shifter 436 is arranged at the coupling between the sixth radiating element 408 and the corresponding, respective interface 406. As will be appreciated, such a variable phase shifter may be arranged at one or more other couplings (with or without such a variable phase shifter being arranged at the coupling between the sixth radiating element and the corresponding, respective interface). In this example, a second variable phase shifter 438 is arranged between the (n−1)^{st} radiating element 408 and the corresponding, respective interface 406.

The components 420 to 438 specified above may be used in order to provide for the difference in signal path length between the various couplings from the corresponding, respective interface to the respective radiating element.

In this example, optimization and management of the signal path length between the signal distribution network and the radiating elements is provided. Therefore, additionally to the above, optimization of the length from the signal distribution network 404 to the interfaces with a progressive increment of the signal path length may be provided, such that a destructive summation of the reverse PIM products through the signal distribution network can be achieved. Destructive interference of the forward PIM products may additionally (or alternatively) be obtained. In order to maintain the antenna properties over frequency and electrical tilt, the cable lengths between the interfaces and the radiating elements and the cable lengths between the interfaces and the signal distribution network 404 may be chosen such that the overall length between the signal distribution network 404 and each of the radiating elements may be the same for an antenna with zero tilt.

FIG. 4b shows a schematic diagram of an antenna 450 according to some example implementations as described herein.

In this example, two radiating elements are combined into a group 452 of radiators/radiating elements. Interfaces 454 are created in the coupling 412 between a device 456 with a power dividing function and the group 452 of radiators/radiating elements. The device 456 may comprise, in some examples, a power splitter and/or a phase shifter and/or a combiner with filters (e.g. a duplexer and/or diplexer).

By grouping radiators/radiating elements, the number of phase shifters in the signal distribution network may be reduced.

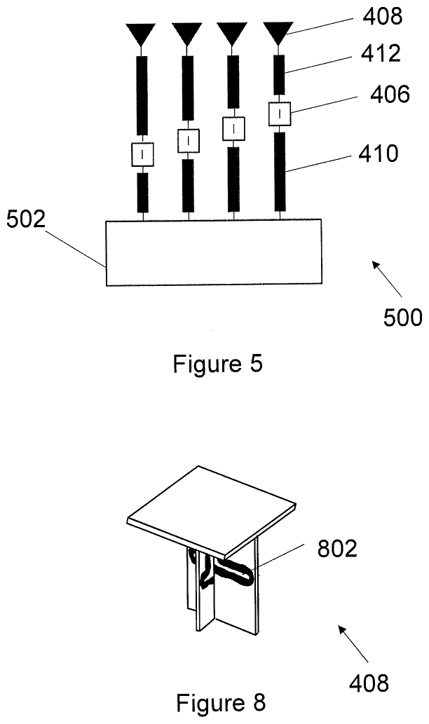

FIG. 5 shows a schematic diagram of an antenna 500 according to some example implementations as described herein. In this example, a signal distribution network and phase shifting section 502 is coupled to the respective couplings 410, which are coupled to the radiating elements 408 via the respective interfaces 406 (possible PIM sources) and the couplings 412. In this example, the signal path length of the couplings 412 changes incrementally for consecutive, neighboring couplings.

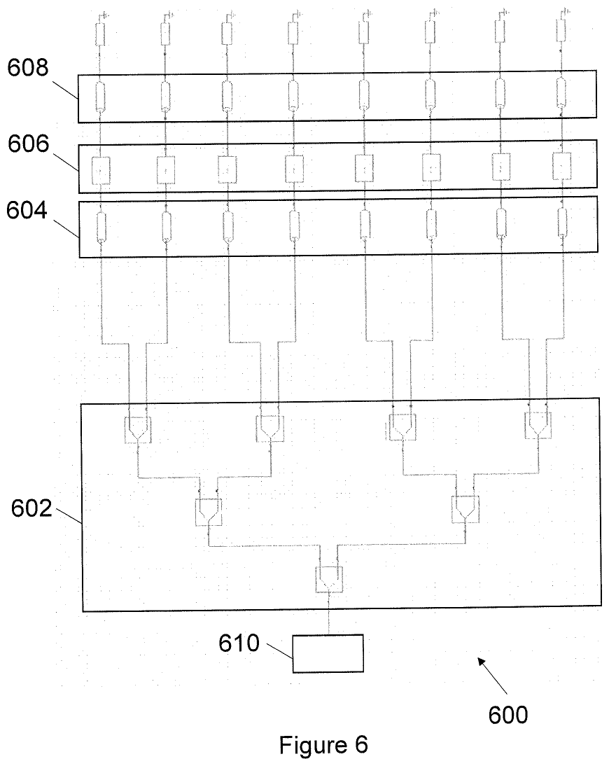

FIG. 6 shows a schematic diagram 600 of an antenna (such as, but not limited to antenna 400 or 500) according to some example implementations as described herein, via which PIM behavior of the antenna was simulated.

In this example simulation, an electrical signal was provided to a splitter part 602 (in this example a 1:8 splitter), from where the electrical signal is provided to loads via simulated cables 604 and 608, each being coupled via corresponding, respective PIM source interfaces 606. A connection point 610 is provided, which may, in some examples, be a solder connection, for example, of a coaxial cable coming from the antenna connector at the antenna housing.

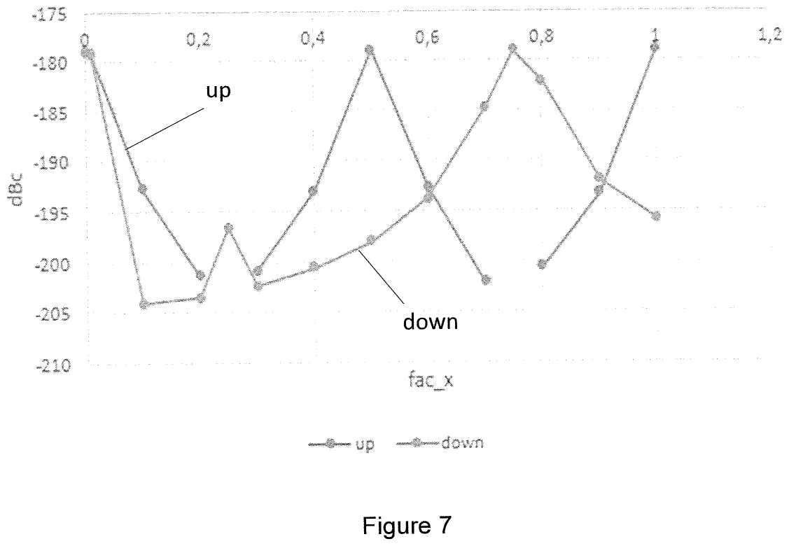

The result of the simulation is depicted in FIG. 7, which shows PIM reduction (in units of dBc) versus difference in signal path length (in units of λ) according to some example implementations as described herein. In this example, two high power carriers are sent to the device under test, with one carrier being fixed while the other carrier is swept. “up” means that the upper frequency remains constant, while the lower frequency is swept up. “down” means that the lower frequency remains constant, while the upper frequency is swept down. In this example, the difference in signal path length changes incrementally between neighboring, consecutive couplings between zero and 1·λ.

The result shows that for a progressive increment of the signal paths at 0.25 times the wavelength of the operating frequency, a maximum cancelation of PIM has been achieved.

For a progressive increment of the signal paths, the difference may be, in this particular example, between a range of 0.05 and 0.5 times the wavelength of the operating frequency and bandwidth.

For the smallest increment of 0.05λ, a reduction of about −4.5 dB can be achieved. For larger increments around 0.25λ, PIM values are better, in this example, around −15 dB up to −20 dB. The given numbers depend on the number of radiators connected, noting that the aforementioned numbers are for eight radiators, while for more radiators the PIM improvement is larger, and for less radiators the PIM improvement is lower.

FIG. 8 shows a perspective view of a schematic illustration of a radiating element 408 according to some example implementations as described herein. In this example, the difference in signal path length is based on a different physical length of an inner conductor 802 in the radiating element 408. Such inner conductor 802, i.e. the length thereof, may be varied between different radiating elements 408. Additionally or alternatively, different radiating elements with different phase-shifting properties may be provided in the antenna. Such different radiating elements may be, for example, a dipole, a slot radiator, patches, etc. Additionally or alternatively, different plastic materials/dielectrics may be provided on the (head of the) radiating element.

As can be seen from the above, PIM improvement can be achieved based on providing a difference in signal path length between the different couplings. This may allow for increasing uplink coverage and consequently improvement in uplink sensitivity. Furthermore, increased throughput/data rates may be obtained. As a result, fewer calls in a telecommunications network may drop.

The decrease or avoidance of PIM through destructive vector addition may additionally provide for cost reduction. Advantages of the antenna described throughout the present disclosure are that the work force training can be a reduced. This is because in antennae according to the state of the art, PIM problems or avoidance may be achieved only through highly trained people in the manufacturing process, because PIM can be caused, for example, by bad soldering and metal chips inside the antenna. Specific know how maybe required in order to avoid PIM, which may therefore increase the production costs by high quality material and high quality labor. The antenna according to example implementations as described herein allows for simple manufacturing in order to reduce or avoid PIM.

Furthermore, by destructive vector addition, one can obtain a better PIM value of the antenna. On the other hand, if the parts or processes have a certain lack of quality, there is nonetheless a lower risk for the product to malfunction or function to a lower degree, because the PIM failure margin is initially higher. The time to market for such an antenna may be improved, since the parts may not be pre-checked prior to operation of the antenna (or pre-checked to a lesser degree compared to antennae of the state of the art) while still providing for the desired characteristics of the antenna. The antenna may also be easily developed and assembled.

An antenna according to example implementations as described herein allows for destructive superposition of the reverse and/or forward PIM product without the need for an active digital PIM cancelation method. Energy consumption may thus be advantageously reduced. The present solution allows for a purely passive method in order to reduce or avoid PIM, such that there is no need for processing resources for a digital PIM avoidance/reduction solution.

It is to be noted that the phase shifting section together with its progressive phase adjustment in order to steer a beam in a certain direction may need to be considered for the PIM mitigation/optimization according to example implementations as described herein.

No doubt many other effective alternatives will occur to the skilled person. It will be understood that the invention is not limited to the described embodiments and encompasses modifications apparent to those skilled in the art and lying within the scope of the claims appended hereto.

1. An antenna comprising:
a signal distribution network configured to distribute, through the antenna, an electrical signal having an antenna operating frequency, f,
a plurality of radiating elements, wherein each one of the radiating elements is electrically coupled to the signal distribution network via a corresponding, respective electrical coupling, wherein each one of the electrical couplings comprises a corresponding, respective interface,
wherein a signal path length, between a first one of said interfaces and a corresponding, respective first one of said radiating elements, of a first one of said electrical couplings differs from a signal path length, between a second one of said interfaces and a corresponding, respective second one of said radiating elements, of a second one of said electrical couplings by at least 0.05 times a wavelength, λ, corresponding to the antenna operating frequency, f.

2. The antenna as claimed in claim 1, wherein the antenna operating frequency, f, is between 698 MHz and 80 GHz, in particular between 698 MHz and 960 MHz, and/or between 1695 MHz and 2690 MHz, and/or between 617 MHz and 746 MHz, and/or between 1695 MHz and 2200 MHz, and/or between 3300 MHz and 3800 MHz, and/or between 5150 MHz and 5925 MHz, and/or between 600 MHz and 6000 MHz, and/or between 24 GHz and 80 GHz.

3. The antenna as claimed in claim 1, wherein the signal path length, between the first interface and the first radiating element, of the first electrical coupling differs from the signal path length, between the second interface and the second radiating element, of the second electrical coupling by less than 1.25λ.

4. The antenna as claimed in claim 1, wherein the signal path length, between the first interface and the first radiating element, of the first electrical coupling differs from the signal path length, between the second interface and the second radiating element, of the second electrical coupling by 0.25λ.

5. The antenna as claimed in claim 1, wherein the antenna comprises at least three radiating elements, and wherein the signal path length, between a said interface and a said corresponding, respective radiating element, of a said electrical coupling increases from any one of said electrical couplings to a corresponding, respective consecutive neighboring coupling by an amount which is between 0.05λ and 1.25λ.

6. The antenna as claimed in claim 5, wherein the amount is a fixed amount between 0.05λ and 1.25λ, and is preferably 0.1λ or 0.2λ or 0.3λ or 0.4λ, more preferably 0.25λ.

7. The antenna as claimed in claim 1, wherein the signal path length, between the first interface and the first radiating element, of the first electrical coupling being different from the signal path length, between the second interface and the second radiating element, of the second electrical coupling is based on one or more of:
an electrical length and/or physical length of the first radiating element, in particular of an inner conductor of the first radiating element, being different from an electrical length and/or physical length of the second radiating element, in particular of an inner conductor of the second radiating element;
a physical length, between the first interface and the first radiating element, of a first electrical cable for the first electrical coupling being different from a physical length, between the second interface and the second radiating element, of a second electrical cable for the second electrical coupling;
a velocity factor of at least a part of the first electrical cable being different from a velocity factor of at least a part of the second electrical cable;
a said first electrical cable being coupled or connected to a first dielectric, and in particular a said second electrical cable being coupled or connected to a second dielectric which is different from the first dielectric;
the first electrical coupling comprising a first reactance and/or a first inductance and/or a first capacitance, and in particular the second electrical coupling comprising a second reactance different from the first reactance and/or a second inductance different from the first inductance and/or a second capacitance different from the first capacitance;
the first radiating element being of a first type and the second radiating element being of a second type, wherein the first type causes a phase delay of a said electrical signal different from a said phase delay caused by the second type;
a third dielectric coupled or connected to the first radiating element and/or a fourth dielectric, different from the third dielectric, coupled or connected to the second radiating element; and
the first radiating element being rotated with respect to an orientation of the second radiating element.

8. The antenna as claimed in claim 1, wherein the signal path length, between the first interface and the first radiating element, of the first electrical coupling being different from the signal path length, between the second interface and the second radiating element, of the second electrical coupling is based on a phase-shifting element or unit, in particular a 90 degree hybrid coupler, being provided in or coupled to one or both of:
the first electrical coupling at a first location between the first interface and the first radiating element, and
the second electrical coupling at a second location between the second interface and the second radiating element.

9. The antenna as claimed in claim 1, wherein the antenna comprises at least four radiating elements, preferably at least eight radiating elements.

10. The antenna as claimed in claim 1, wherein the antenna is a multiple-input multiple-output, MIMO, antenna.

11. The antenna as claimed in claim 1, wherein a said interface comprises one or more of:
a soldering joint,
an electrical connector, and
an interface of an electrical component, in particular of a power splitter and/or a filter and/or a phase delay element.

12. The antenna as claimed in claim 1, wherein the antenna further comprises a variable phase shifter, coupled or connected (i) between the first interface and the first radiating element to the first electrical coupling and/or (ii) between the second interface and the second radiating element to the second electrical coupling, for shifting a said electrical signal transmitted on (i) the first electrical coupling between the first interface and the first radiating element and/or (ii) the second electrical coupling between the second interface and the second radiating element.

13. The antenna as claimed in claim 1, wherein the antenna further comprises a first variable phase shifter and/or a first electrically controllable reactance and/or a fifth dielectric coupled to or comprised in the first electrical coupling, for shifting a said electrical signal transmitted on the first electrical coupling between the first interface and the first radiating element.

14. The antenna as claimed in claim 13, further comprising a second variable phase shifter and/or a second electrically controllable reactance and/or a sixth dielectric, different from the fifth dielectric, coupled to or comprised in the second electrical coupling, for shifting a said electrical signal transmitted on the second electrical coupling between the second interface and the second radiating element.

15. The antenna as claimed in claim 12, wherein a said variable phase shifter is configured to vary a mechanical length of a said electrical coupling for shifting a said electrical signal.

16. The antenna as claimed in claim 12, wherein a said variable phase shifter comprises a movable dielectric.

17. The antenna as claimed in claim 1, wherein one or more of said radiating elements each comprises a group of radiators, and wherein the signal path length between a said interface and a said corresponding, respective radiating element comprises a signal path length between said interface and a feed point of each of the radiators of the corresponding, respective group of radiators.

18. The antenna as claimed in claim 17, wherein, when the signal path lengths between (i) a said interface and (ii) at least two radiators, respectively, of the corresponding group of radiators differ from each other, the signal path length between the interface and the group of radiators is based on a mean value of said signal path lengths between said interface and the radiators of the corresponding, respective group of radiators.
